(19) United States
(12) Patent Application Publication
(10) Pub. No.: US 2003/0110476 A1
(43) Pub. Date: Jun. 12, 2003

(54) Source code debugger, debugging method and debugging program

(76) Inventor: Masami Aihara, Tokyo (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/241,237

(22) Filed: Sep. 11, 2002

(30) Foreign Application Priority Data
Dec. 9, 2001 (JP) P2001-277196

(51) Int. Cl. G06F 9/44

(52) U.S. Cl. 717/135

(57) ABSTRACT

A source code debugger connected to a cycle-accurate instruction set simulator, comprising: a pipeline information obtaining module configured to obtain address information in execution at respective stages on a pipeline from the cycle-accurate instruction set simulator; a pipeline information displaying module configured to edit the address information of the pipeline obtained by the pipeline information obtaining module together with the progress of processing of the stages; a resource information obtaining module configured to obtain address information of a program in execution together with instruction codes; and a resource information displaying module configured to edit the address information and the instruction codes obtained by the resource information obtaining module.

### CROSS REFERENCE TO RELATED APPLICATIONS

This application is based upon and claims the benefit of priority from prior Japanese Patent Application P2001-277196 filed on Sep. 12, 2001; the entire contents of which are incorporated by reference herein.

### BACKGROUND OF THE INVENTION

1. Field of the Invention

The present invention relates to source code debuggers for use in software development, more specifically, to a source code debugger, a debugging method and a debugging program, which respond to cycle-accurate ISS taking account of pipeline processing used in hardware-software co-simulation environment.

2. Description of the Related Art

Hardware-software co-simulation environment is becoming widespread as an environment for improving efficiency in the development of system LSIs including microprocessors. The hardware-software co-simulation environment is constructed by the integration of a logic simulator, being a conventional hardware development tool, and a processor instruction set simulator (ISS), being a software development tool.

A conventionally used ISS (hereinafter referred to as a “conventional ISS”) is designed to simulate an operation of a processor by each instruction. Meanwhile, the conventional ISS does not consider pipeline stages even if the processor adopts a pipeline processing system.

In general, a source code debugger is used for controlling the execution of and displaying results from the conventional ISS (such a source code debugger is hereinafter referred to as a “conventional source code debugger”). Famous source code debuggers includes “MULTI” by Green Hills Software, “XRAY” by Mentor Graphics, “GDB” by Red Hat, and the like. FIG. 1 shows one example of a constitution of a conventional source code debugger 2. Resource information obtaining module 11 can obtain information concerning resources such as a program counter (PC) 25, a general register and a memory, which are accessible by a normal software program, getting from a conventional ISS 20. Meanwhile, resource information displaying module 12 can display the information on a display device 13.

As a displaying method therein, it is a general practice to display the source codes of a program affixed with marks in positions indicated according to values in the PC so that the ISS indicates which part of the program is in execution as shown in a display example of FIG. 2, or to display a list of contents of the general register as shown in FIG. 3. Moreover, an ISS controlling module 14 can halt execution of the ISS when the process reaches a preset breakpoint. Further, the ISS controlling module 14 can also allow the ISS to execute the program starting from that point in steps (which refer to one instruction of the machine instructions or one line in a program written in a high-level language such as the C language), or alternatively, to execute the program continuously until the next breakpoint. The program can be verified by confirming how the contents of the register and the memory are changed, by use of the ISS controlling module 14 and the display on the display device 13.

However, with the spread of the hardware-software co-simulation, an ISS designed to be cycle-accurate, by taking pipeline processing into consideration to achieve timing accuracy with a logic simulator (such an ISS is hereinafter referred to as a “cycle-accurate ISS”), has recently come into use.

Although the ISS used in the hardware-software co-simulation environment has changed from the conventional ISS to the cycle-accurate ISS, the source code debuggers currently in use continue to fail to account for the pipeline processing. Accordingly, the conventional source code debugger tends to incur the following problems upon displaying a result of the cycle-accurate ISS, which may cause a user to misunderstand the result.

FIG. 2 shows the state in a display frame of the conventional source code debugger 2, where the ISS is currently halted immediately before the execution of an instruction “LD $3,0($12)” at the address 0x80020200. FIG. 3 shows register information for the state shown in FIG. 2. Now, consideration will be made based on the assumption that a program is executed in steps (which refers to one instruction sentence because the program is written in a machine language).

FIG. 4 is an example of a result display of the execution of the program one step forward from the state shown in FIG. 2, using the conventional ISS. Since the conventional ISS is controlled to execute the program by each instruction sentence, the instruction “LD $3,0($12)” is completed when the ISS proceeds with the execution of one step. In other words, as shown in register information of FIG. 5, the content of memory indicated by the register $12 (0x00000064: not shown) is loaded on the register $3, whereby the PC value is incremented to 0x80020204.

FIG. 6 shows an example of a result display of the execution of the program one step forward from the state shown in FIG. 2, using the cycle-accurate ISS. A pipeline is assumed to be composed of five stages of “fetch (F)/decode (D)/execute (E)/memory access (M)/write back (W)”. Since the cycle-accurate ISS takes the pipeline processing into consideration, the execution of one step refers to the execution of one pipeline stage. Therefore, in FIG. 6, the F stage of the instruction “LD $3,0($12)” is executed as the cycle-accurate ISS proceeds with execution of one step. Accordingly, the cycle-accurate ISS reads the instruction, whereby the PC value is incremented to 0x80020204 as shown in the register information in FIG. 7. Incidentally, the readout of the content of the memory indicated by the register $12 is carried out at the M stage, and loading on the register $3 is carried out at the W stage. Therefore, the value of the register $3 does not change at this point. Accordingly, the register $3 stays the value 0x00000000.

In this way, arrows indicating the point of execution point the same address 0x80020204 in both FIG. 4 and FIG. 6. However, the contents of the register $3 are different when FIG. 5 and FIG. 7 are compared. In order to judge whether the result is correct or wrong, a user always has to grasp the situations at each respective pipeline stage. However, the operations of the pipeline are quite complicated. Accordingly, there is a problem that the user is prone to misunderstand the value 0x00000000 as the data being loaded on the register $3. Occurrence of such a problem is not always limited to the case of the LD instruction, but similar problems may occur in the case of a storing instruction or an operating instruction.

Meanwhile, a display example in FIG. 8 shows the state where the ISS is halted immediately before execution of an instruction “BNE $2,$3,0x5” at the address 0x80020200. The instruction “BNE $2,$3,0x5” refers to an instruction to compare the values between the register $2 and the register $3 and to branch the program toward an instruction 5 steps ahead if the values do not coincide with each other. Here, the values of the register $2 and the register $3 are assumed not to be coincident. Now, consideration will be made based on the assumption that the program is executed similarly in each step.

FIG. 9 shows an example of a result display of the execution of the program from the state shown in FIG. 8 by use of the conventional ISS 20. As the conventional ISS proceeds with the execution of the program for each step, the conventional ISS computes the address of a branch destination (which is 0x80020214) and sets up the value on the PC because the values of the register $2 and the register $3 do not coincide with each other. Accordingly, the value of the PC is set to 0x80020214 and an arrow for indicating the point of execution is pointing at the value 0x80020214.

FIG. 10 shows an example of a result display of the execution of the program one step forward from the state shown in FIG. 8 using the cycle-accurate ISS. As the cycle-accurate ISS only executes the F stage of the BNE instruction, the value of the PC is incremented to 0x80020204. Accordingly, an arrow indicating the point of execution points at the value 0x80020204. In this case, there is a problem that the user is prone to the misunderstanding that a branching condition was not satisfied. A similar problem will also occur in the case of a jump instruction.

As described above, as the results of the cycle-accurate ISS are often used with the conventional source code debugger 2 under the hardware-software co-simulation environment, the conventional source code debugger 2 cannot display the information concerning the pipeline because the conventional source code debugger 2 does not correspond to the cycle-accurate ISS. Accordingly, the user is always required to grasp the situation at each respective pipeline stage. Otherwise, the problem arises that the user is prone to misunderstand the result.

### SUMMARY OF THE INVENTION

A first aspect of the present invention is to provide a source code debugger connected to a cycle-accurate instruction set simulator, comprising: a) a pipeline information obtaining module configured to obtain address information in execution at respective stages on a pipeline from the cycle-accurate instruction set simulator; b) a pipeline information displaying module configured to edit the address information of the pipeline obtained by the pipeline information obtaining module together with the progress of processing of the stages; c) a resource information obtaining module configured to obtain address information of a program in execution together with instruction codes; and d) a resource information displaying module configured to edit the address information and the instruction codes obtained by the resource information obtaining module.

A second aspect of the present invention is to provide a source code debugger connected to a cycle-accurate instruction set simulator, comprising: a) means for obtaining address information in execution at respective stages on a pipeline from a cycle-accurate instruction set simulator; b) means for editing the address information of the pipeline obtained by the pipeline information obtaining means together with the progress of processing of the stages; c) means for obtaining address information of a program in execution together with instruction codes; and d) means for editing the address information and the instruction codes obtained by the resource information obtaining means.

A third aspect of the present invention is to provide a method for use in a system comprising a source code debugger and a cycle-accurate instruction set simulator connected to the source code debugger, comprising: a) obtaining address information in execution at respective stages on a pipeline from the cycle-accurate instruction set simulator; b) editing the address information of the pipeline together with the progress of processing of the stages; c) obtaining address information of a program in execution together with instruction codes; and d) editing the address information and the instruction codes.

A fourth aspect of the present invention is to provide a computer program product for controlling a system comprising a source code debugger and a cycle-accurate instruction set simulator connected to the source code debugger, comprising: a) instructions configured to obtain, by pipeline information obtaining, address information in execution at respective stages on a pipeline from the cycle-accurate instruction set simulator; b) instructions configured to edit, by pipeline information displaying, the address information of the pipeline together with progress of processing of the stages; c) instructions configured to obtain, by resource information obtaining means, address information of a program in execution together with instruction codes; and d) instructions configured to edit, by resource information displaying module, the address information and the instruction codes.

### BRIEF DESCRIPTION OF DRAWINGS

FIG. 1 is a block diagram of a conventional source code debugger.

FIG. 2 is a source code display frame of the conventional source code debugger immediately before an LD instruction.

FIG. 3 is a register information display frame in the state of FIG. 2.

FIG. 4 is a source code display frame of the conventional source code debugger showing a state of executing the LD instruction from the state shown in FIG. 2 by use of a conventional ISS.

FIG. 5 is a register information display frame in the state of FIG. 4.

FIG. 6 is a source code display frame of the conventional source code debugger showing a state of executing the LD instruction from the state shown in FIG. 2 by use of a cycle-accurate ISS.

FIG. 7 is a register information display frame in the state of FIG. 6.

FIG. 8 is a source code display frame of the conventional source code debugger immediately before a BNE instruction.

FIG. 9 is a source code display frame of the conventional source code debugger showing a state of executing the BNE instruction from the state shown in FIG. 8 by use of the conventional ISS.

FIG. 10 is a source code display frame of the conventional source code debugger showing a state of executing the BNE instruction from the state shown in FIG. 8 by use of the cycle-accurate ISS.

FIG. 11 is a block diagram of a source code debugger according to a first embodiment of the present invention.

FIG. 12 is a flowchart describing operations of the source code debugger according to the first embodiment of the present invention.

FIGS. 13A and 13B are examples of a source code display frame of the source code debugger according to the first embodiment of the present invention.

FIGS. 14A and 14B are examples of a source code display frame of a source code debugger according to a second embodiment of the present invention.

FIG. 15 is an example of a source code display frame of a source code debugger according to a third embodiment of the present invention.

FIGS. 16A and 16B are examples of a source code display frame of a source code debugger according to a fourth embodiment of the present invention.

FIG. 17 is a block diagram of a source code debugger according to a fifth embodiment of the present invention.

FIG. 18 is a flowchart describing operations of the source code debugger according to the fifth embodiment of the present invention.

FIG. 19 is an example of a source code display frame of the source code debugger according to the fifth embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

(First Embodiment)

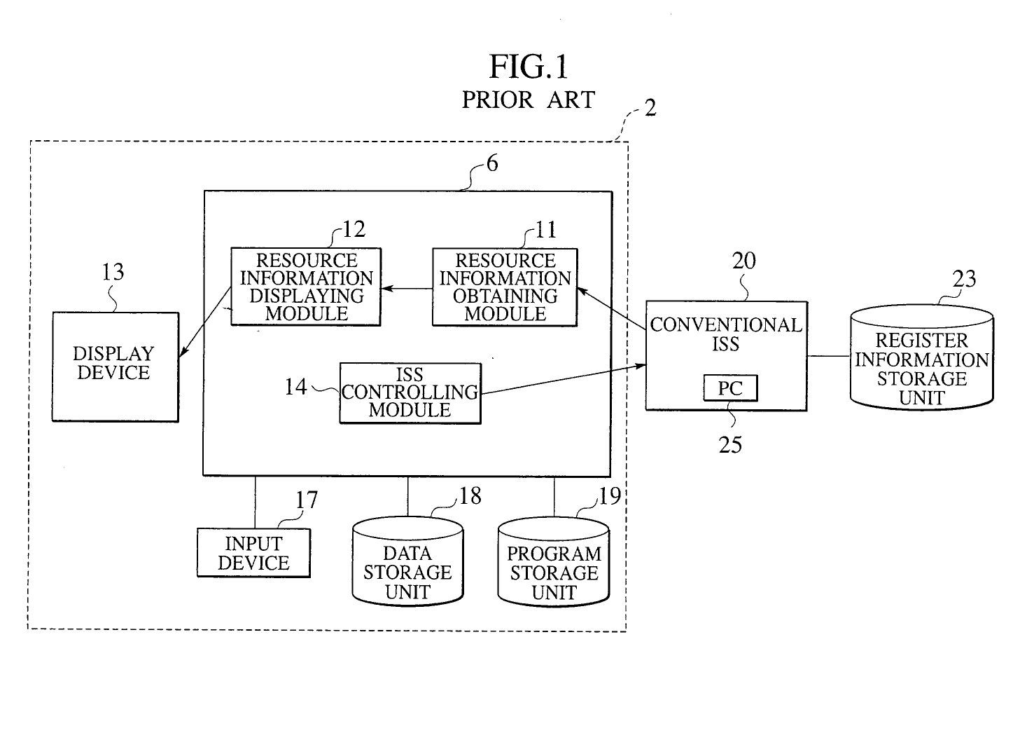

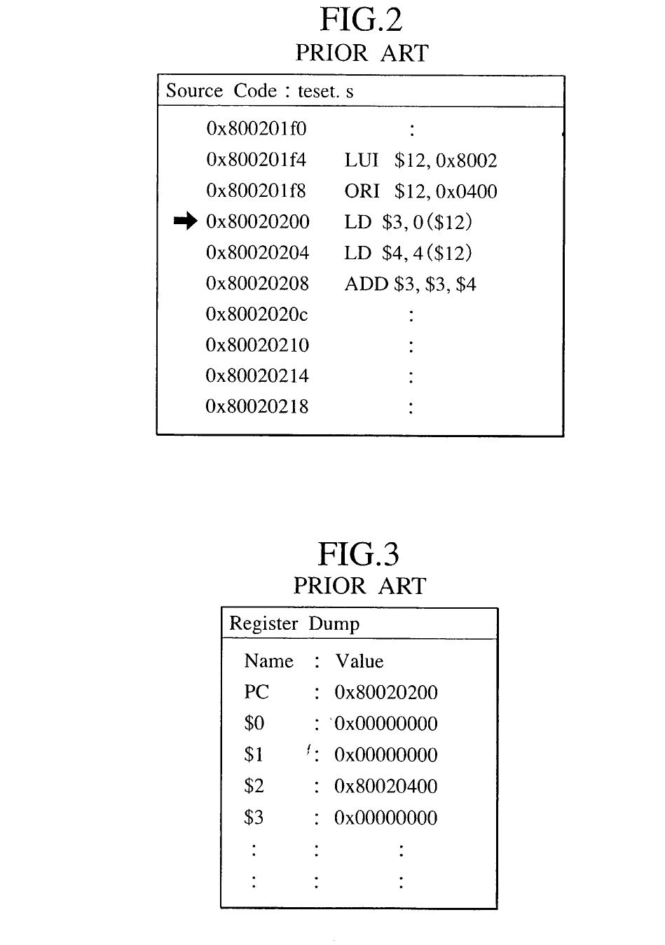

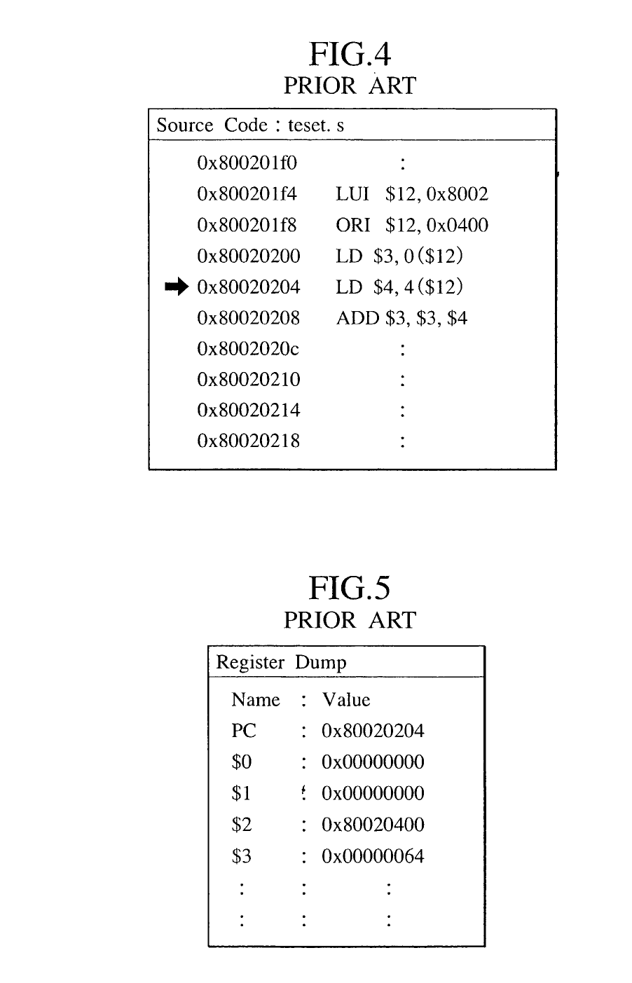

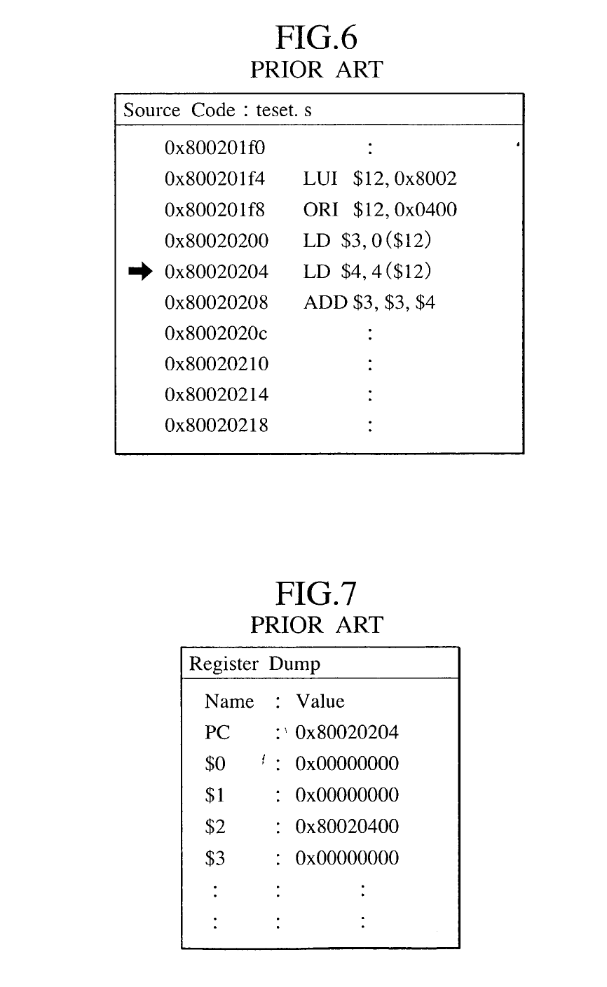

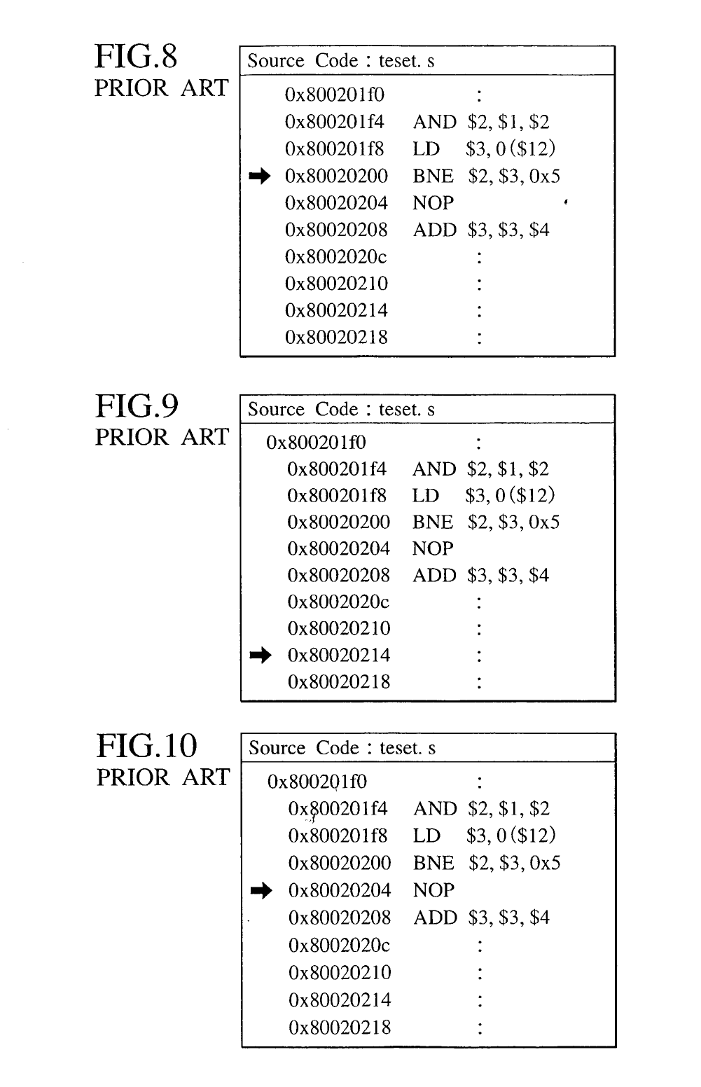

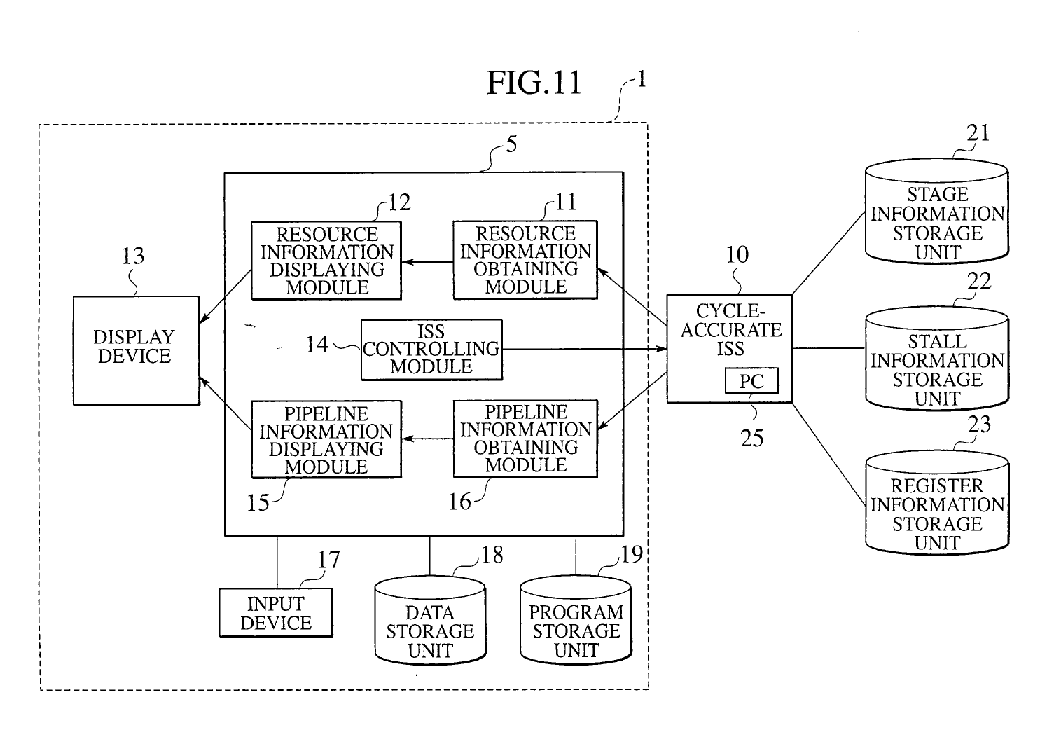

FIG. 11 is a block diagram showing a constitution of a source code debugger 1 according to a first embodiment of the present invention. The source code debugger 1 according to the first embodiment includes a central processing unit (CPU) 5, a display device 13, an input device 17, a data storage unit 18, and a program storage unit 19. The display device 13, the input device 17, the data storage unit 18, and the program storage unit 19 are respectively connected to the CPU 5, so that information concerning a pipeline in a cycle-accurate instruction set simulator (ISS) 10 can be displayed and the situation of the execution of respective instructions on the pipeline can be thereby grasped adequately. The CPU 5 includes a resource information obtaining module (means) 11, a resource information displaying module (means) 12, an ISS controlling module 14, a pipeline information displaying module (means) 15 and a pipeline information obtaining module (means) 16. The CPU 5 includes the pipeline information displaying module 15 and the pipeline information obtaining module 16 in addition to the constitution of the CPU 6 of the conventional source code debugger 2 shown in FIG. 1. Further, the cycle-accurate ISS 10 is connected to the source code debugger 1. The display device 13 refers to the screen of a monitor or the like. A liquid crystal display (LCD) device, a light-emitting diode (LED) panel, an electroluminescence (EL) panel and the like can be used as the display device 13. The input device 17 refers to an instrument such as a keyboard or a mouse. When an inputting operation is performed with the input device 17, relevant key information is transmitted to the CPU 5. The data storage unit 18 temporarily stores data in progress of calculation or analysis in the course of processing by the CPU 5. The program storage unit 19 stores a program for obtaining the pipeline information or displaying the obtained information, which is to be executed by the CPU 5.

Meanwhile, a stage information storage unit 21, a stall information storage unit 22 and a register information storage unit 23 are connected to the cycle-accurate ISS 10. The stage information storage unit 21 stores information as to which instruction is in execution at each stage of the pipeline, in order to take the pipeline processing into consideration. The stall information storage unit 22 stores information as to whether each stage is in an executable condition or a stalled condition. And, the register information storage unit 23 stores information concerning the dependency relations of the registers designated as operands of the respective instructions in progress of processing on the pipeline, in order to judge whether the pipeline will stall or not.

Here, the “cycle-accurate instruction set simulator” refers to an instruction set simulator which simulates an operation of a processor not by the instruction, but by the stage such as fetch (F)/decode (D)/execute (E)/memory access (M)/write back (W) or the like, while taking the pipeline processing into consideration. In the following, “address information of the instruction in execution at each stage of the pipeline” refers to addresses being executed by the respective stages of fetch (F)/decode (D)/execute (E)/memory access (M)/write back (W) and the like. Moreover, “address information of the program in execution” refers to an address of a source code initiated for execution. In the cycle-accurate instruction set simulator, the address information of the program in execution refers to the address in which the fetch (F) stage is initiated.

The resource information obtaining module 11 embedded in the CPU 5 of the source code debugger 1 according to the first embodiment obtains the address information provided by the program counter 25, instruction codes and the like of the program (or the source code) in execution from the cycle-accurate ISS 10. The resource information displaying module 12 of the CPU 5 executes necessary edition processing so as to display the address information, the instruction codes and the like obtained by the resource information obtaining module 11 on the display device 13. Moreover, the pipeline information obtaining module 16 of the CPU 5 obtains the address information of the instruction in execution at each stage of the pipeline, information of registers in execution and the like from the cycle-accurate ISS 10. The pipeline information displaying module 15 of the CPU 5 executes necessary edition processing so as to display the information obtained by the pipeline information obtaining module 16 on the display device 13. Moreover, the ISS controlling module 14 of the CPU 5 controls operations of the cycle-accurate ISS 10.

According to the source code debugger of the first embodiment, it is possible to display information concerning the pipeline owned by the cycle-accurate ISS in progress of executing software simulation in the hardware-software co-simulation environment. Accordingly, it is possible to grasp situations of the execution of the respective instructions on the pipeline accurately.

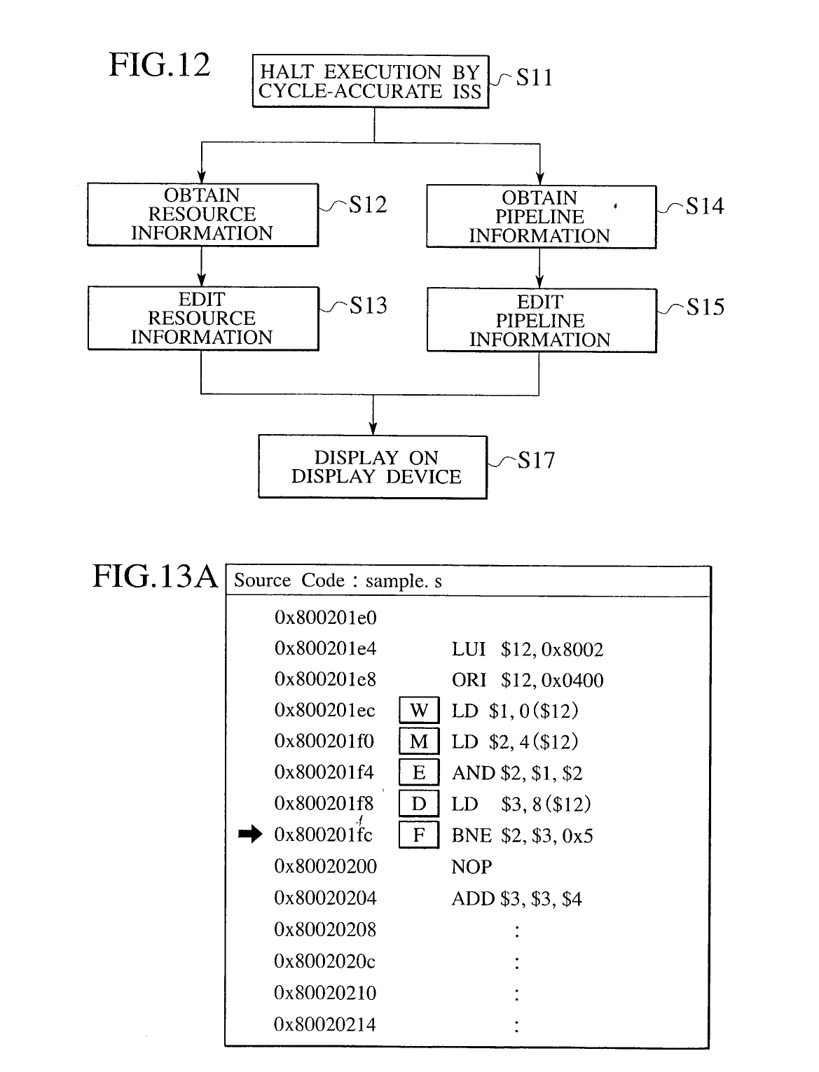

Now, description will be made regarding operations of the source code debugger 1 with reference to FIG. 12.

(a) In Step S11, the ISS controlling module 14 halts execution by the cycle-accurate ISS 10.

(b) Next, in Step S12, the resource information obtaining module 11 obtains the address information provided by the PC 25, the instruction codes and the like of the program in execution from the cycle-accurate ISS 10. Then, in Step S13, the resource information displaying module 12 performs edition processing to display on the display device 13, information such as the edition of the address and the instruction codes, addition of an arrow on the source code of the program in a position corresponding to a value owned by the PC 25, or the like.

(c) Meanwhile, in Step S14, the pipeline information obtaining module 16 obtains the address information of the instruction in execution at each stage of the pipeline. Next, in Step S15, the pipeline information displaying module 15 adds marks relevant to the stages where the respective instructions are executed to positions corresponding to the respective addresses on the source code, and performs editing for displaying on the display device 13. Moreover, the pipeline information displaying module 15 also displays the register information in progress simultaneously.

(d) Then, in Step S17, the progress of processing the address information and the stage information, the instruction codes and the like are displayed on the display device 13 based on the results of the edition processing in Steps S13 and S15. In this way, it is possible to grasp the current position of the program processing, the progress of processing at the respective stages and the like.

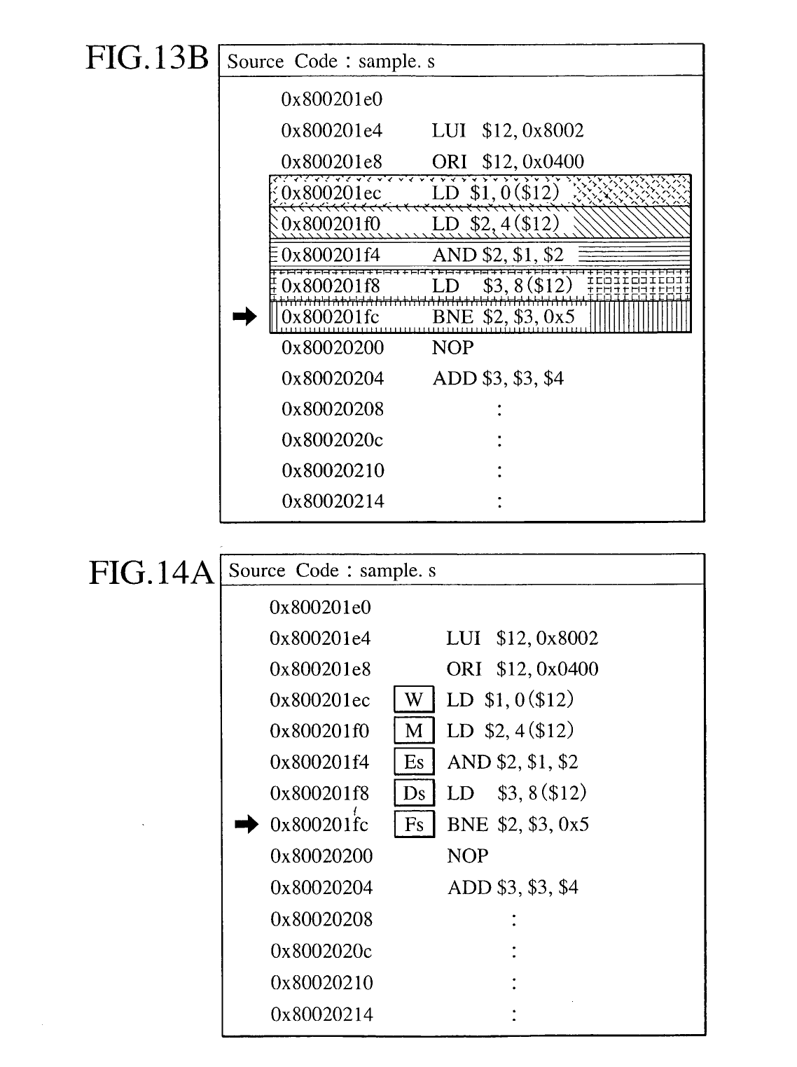

Now, description will be made regarding a concrete example of a display on the display device 13 with reference to FIG. 13A and FIG. 13B.

FIG. 13A shows one example of a screen display in the case of displaying the source code on the display device 13. An arrow in front of an address indicates a current position of execution of the program, and signs F, D, E, M and W between the addresses and the instruction codes indicate that the relevant instructions are at the F stage, the D stage, the E stage, the M stage and the W stage, respectively. According to the display in FIG. 13A, it is possible to grasp accurately which stage each instruction is located at. For example, the instruction “LUI $12,0x8002” at the address 0x800201e4 and the instruction “ORI $12,0x0400” at the address 0x800201e8 are instructions for initializing the register $12, which have been executed already. The instruction “LD $1,0($12)” at the address 0x800201ec is the instruction for loading content of the memory designated by the value in the register $12 onto the register $1, in which the W stage is about to be executed. The instruction “LD $2,4($12)” at the address 0x800201f0 is the instruction for loading a content of the memory designated by the value in the register $12 plus 4 onto the register $2, in which the M stage is about to be executed. The instruction “AND $2,$1,$2” at the address 0x800201f4 is the instruction for operating a logical product (AND) between the value in the register $1 and the value in the register $2 and storing the result in the register $2, in which the E stage is about to be executed. The instruction “LD $3,8($12)” at the address 0x800201f8 is the instruction for loading content of the memory designated by the value in the register $12 plus 8 onto the register $3, in which the D stage is about to be executed. The instruction “BNE $2,$3,0x5” at the address 0x800201 fc is the instruction for comparing the values between the register $2 and the register $3 and branching the process toward the instruction five steps ahead if the values do not equal to each other, in which the F stage is about to be executed. The instruction “NOP” at the address 0x80020200 is the instruction for no operation and the instruction “ADD $3,$3,$4” at the address 0x80020204 is the instruction for adding the values between the register $3 and the register $4 and storing the result in the register $3, which are yet to be executed.

As described above, since the instruction “LD $3,8($12)” at the address 0x800201f8 is on a phase where the D stage is about to be executed, it is easily confirmable that loading onto the register $3 is not yet completed. Therefore, if the value in the register $3 is checked in this state, it is possible to avoid the misinterpretation that an incorrect value has been loaded thereon.

Meanwhile, FIG. 13B shows one example of another mode of displaying the stage information of the pipeline. Whereas the signs F, D, E, M and W are indicated as relevant to the names of the pipeline stages by the pipeline information displaying module in FIG. 13A, the respective stages are displayed in different colors in FIG. 13B. For example, the instruction “BNE $2,$3,0x5” at the address 0x800201fc at the F stage is indicated in red, the instruction “LD $3,8($12)” at the address 0x800201f8 at the D stage is indicated in yellow, the instruction “AND $2,$1,$2” at the address 0x800201f4 at the E stage is indicated in blue, the instruction “LD $2,4($12)” at the address 0x800201f0 at the M stage is indicated in green, and the instruction “LD $1,0($12)” at the address 0x800201ec at the W stage is indicated in orange. Alternatively, the respective stages of the pipeline may be displayed by different hatching patterns.

According to the source code debugger of the first embodiment, not only the position of execution on the source code but also the stage situation of the pipeline are confirmable. In this way, it is possible to grasp accurate operational conditions without misunderstanding the results.

(Second Embodiment)

The source code debugger according to the first embodiment displays only the stage information of the pipeline. On the contrary, a source code debugger according to a second embodiment also displays stall information of the pipeline stage in addition thereto.

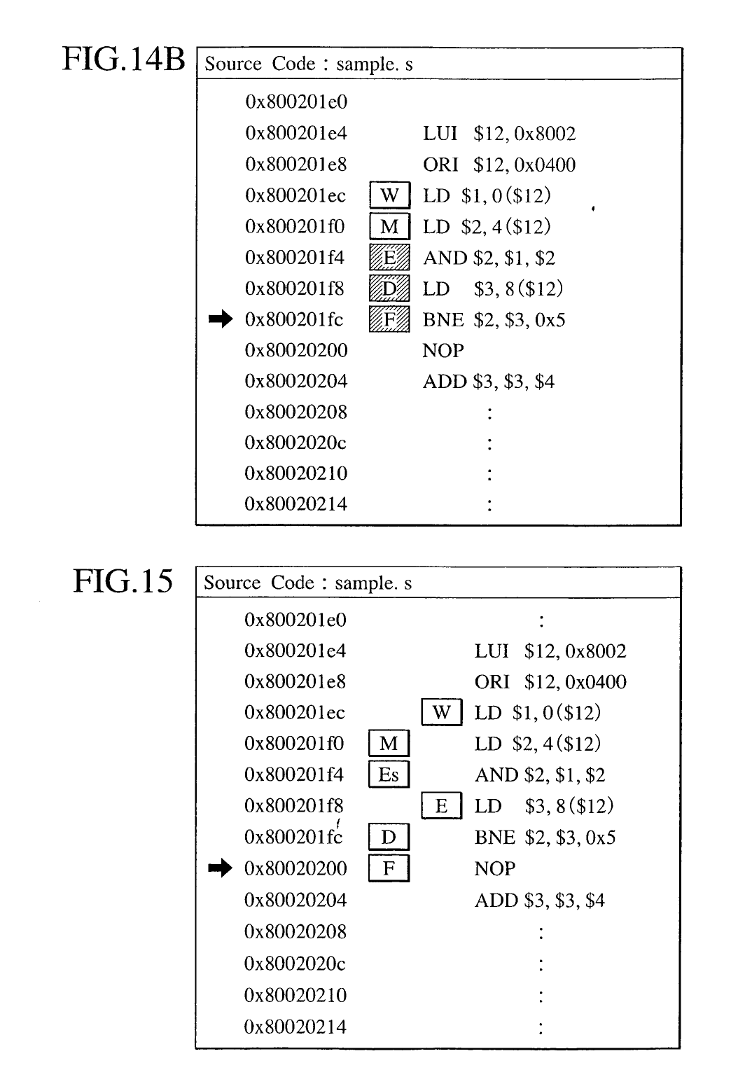

FIG. 14A is a view showing the stall information of the pipeline stages in an identical state and in addition to the display in FIG. 13A.

FIG. 14A illustrates the example of obtaining the pipeline stage information and the stall information of the respective stages by the pipeline information obtaining module 16 of the CPU 5 in FIG. 11 and displaying the information on the source code by the pipeline information displaying module 15. Upon displaying as to which stages the respective instructions in execution with the pipeline are located at, the stall states of the respective stages are displayed simultaneously. The marks representing the stages affixed with small “s” letters indicate that the relevant stages are stalled. According to FIG. 14A, it is confirmable that the instructions at the address 0x800201ec is at the W stage, the instruction at the address 0x800201f0is at the M stage, the instruction at the address 0x800201f4 is at the E stage, the instruction at the address 0x800201f8 is at the D stage, and the instruction at the address 0x800201fc is at the F stage. In addition, it is also confirmable that the instructions at the E, D and F stages are stalled.

For example, FIG. 13A which does not display the stall information indicates that the instruction “AND $2,$1,$2” at the address 0x800201f4 will proceed with the E stage upon execution of the next step. However, one step forward from that state, the E stage will not be actually executed. This is attributable to the fact that the value in the register $2 designated as the operand is set by the immediately precedent instruction “LD $2,4($12)”; nevertheless, the $2 value is not fixed yet at this stage because the instruction is in progress of execution of the M stage. Accordingly, execution of the E stage is stalled. As a result, the AND operation between $1 and $2 is not executed and $2 is not updated in the display of FIG. 13A. Such an aspect might incur misunderstanding that the result is incorrect. On the contrary, since the display in FIG. 14A indicates the stalled information of the stages, it is thereby possible to confirm which stages are stalled. Therefore, it is possible to avoid the misunderstanding as described above.

Moreover, FIG. 14B is an example of indicating stalled stages according to another displaying mode. When the instructions located at the E stage, the D stage and the W stage are stalled, marks indicating the stalled stages are highlighted in reverse video or in a different color.

According to the source code debugger of the second embodiment, the stage information of the pipeline and the stall information of the respective stages can be displayed simultaneously, whereby it is possible to grasp a prospective situation upon executing the next step accurately.

(Third Embodiment)

A source code debugger according to a third embodiment can be adapted to a processor having a plurality of pipelines for processing instructions.

FIG. 15 is a view showing one example of source code display of a source code debugger 5 which corresponds to a cycle-accurate ISS 10 of a processor having 2 pipelines for processing instructions. Two pieces of stage information currently in execution can be displayed between addresses and instruction codes. In this case, the cycle-accurate ISS 10 obtains information regarding the instructions in execution at respective stages on a pipeline 1 and a pipeline 2 severally by pipeline information obtaining module 16. Accordingly, it is possible to obtain and display the information regarding the respective pipelines without the addition of any special means to the constitution of the source code debugger 1 shown in FIG. 11.

In FIG. 15, information regarding the pipeline 1 is displayed on the left side and information regarding the pipeline 2 is displayed on the right side. It is confirmable that the instruction at the address 0x80020200 at the F stage, the instruction at the address 0x800201fc at the D stage, the instruction at the address 0x800201f4 at the E stage and the instruction at the address 0x800201f0 at the M stage regarding the pipeline 1 are in execution, and that the instruction at the address 0x800201f8 at the E stage and the instruction at the address 0x800201ec at the W stage regarding the pipeline 2 are in execution (in which the E stage of the pipeline 1 is stalled).

The number of the pipelines is not limited to two lines. When the number of the pipelines is three or more lines, it is possible to grasp the situation of all the pipelines simultaneously by adding columns for displaying the additional information to the display in FIG. 15.

According to the source code debugger of the third embodiment, it is possible to grasp information regarding a plurality of pipelines simultaneously.

(Fourth Embodiment)

A source code debugger according to a fourth embodiment can display situations of registers concerning pipeline processing on a screen.

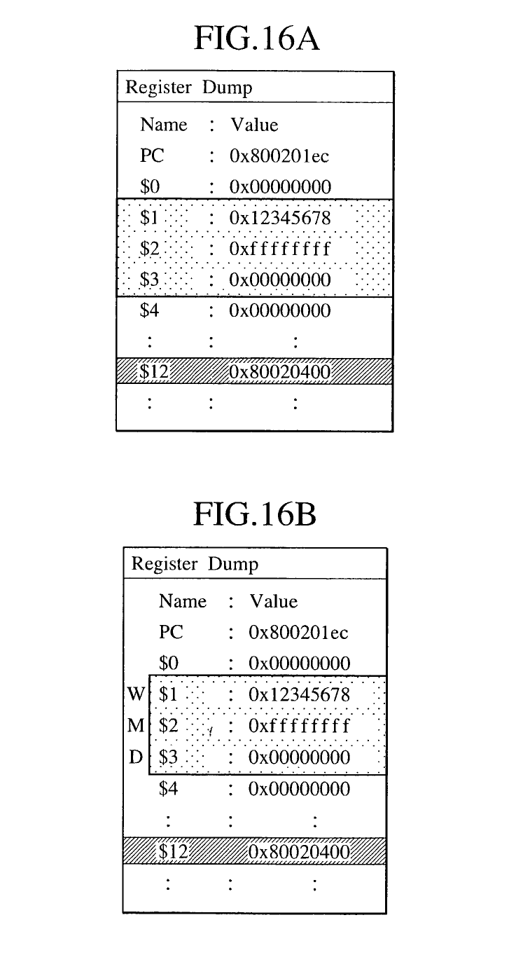

FIG. 16A shows one example of displaying the register information in the state identical to the state in FIG. 13A. In the event of displaying the source code as shown in FIG. 13A, the cycle-accurate ISS 10 stores information concerning the registers targeted by the instructions in progress of the pipeline processing in order to determine as to whether the pipeline is stalled or not. FIG. 16A shows the example of obtaining the information by pipeline information obtaining module 16 and displaying the register information as a list using pipeline information displaying module 17.

The reverse video in the drawing indicates that the relevant register is updated in the course of the step immediately preceding. As is clear from FIG. 13A, the instruction “ORI $12,0x0400” is completed in the step immediately preceding, and the operation result is stored in the register $12. Accordingly, the register $12 is highlighted in reverse video in FIG. 16A. Moreover, hatched display in the drawing indicates the registers currently targeted by the instructions in progress on the pipeline. According to FIG. 13A, the registers currently targeted by the instructions in progress on the pipeline are three registers of $1 (targeted by the instruction at the address 0x800201ec), $2 (targeted by the instructions at the addresses 0x800201f0 and 0x800201f4) and $3 (targeted by the instruction at the address 0x800201f8). Therefore, three registers $1, $2 and $3 are subjected to hatched display in FIG. 16A.

Meanwhile, FIG. 16B also displays stage situations of the instructions targeting the relevant registers in addition to the registers in hatched display in FIG. 16A. It is evident from FIG. 16B that the instruction at the address 0x800201ec targeting the register $1 is at the W stage, the instruction at the address 0x800201f0 targeting the register $2 is at the M stage, and the instruction at the address 0x800201f8 targeting the register $3 is at the D stage. Here, the register ($2) targeted by a plurality of instructions is indicated only at the stage (the M stage) for updating the value earliest. However, it is also possible that the relevant register is indicated at all the stages (the M stage and the E stage).

According to the source code debugger of the fourth embodiment, it is possible to clearly grasp the registers targeted by the instructions currently in progress on the pipeline. Therefore, it is easily possible to judge whether a value displayed on a register information screen is an updated value or a value yet to be updated.

(Fifth Embodiment)

A source code debugger according to a fifth embodiment can display a source code display frame and a register information display frame by dividing a frame into pluralities.

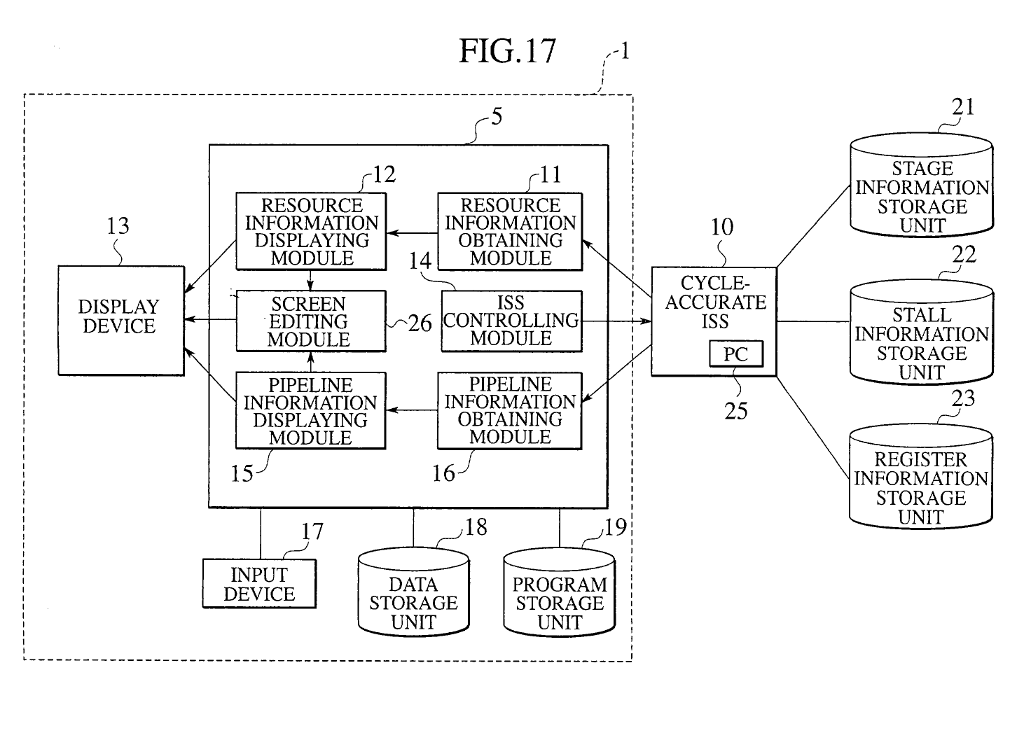

FIG. 17 is a block diagram showing a constitution of a source code debugger 1 according to the fifth embodiment of the present invention. The source code debugger 1 according to the fifth embodiment includes a central processing unit (CPU) 5, a display device 13, an input device 17, a data storage unit 18, and a program storage unit 19, which are severally connected to the CPU 5. The CPU 5 includes resource information obtaining module 11, resource information displaying module 12, ISS controlling module 14, pipeline information displaying module 15, pipeline information obtaining module 16, and screen editing module 26. As compared to the source code debugger 1 according to the first embodiment as shown in FIG. 11, the CPU 5 of the fifth embodiment includes the screen editing module 26 in addition to the constitution of the CPU 5 of the source code debugger 1 according to the first embodiment.

Since description has been made regarding the resource information obtaining module 11, the resource information displaying module 12, the ISS controlling module 14, the pipeline information displaying module 15 and the pipeline information obtaining module 16 already in the first embodiment, similar explanation will be omitted herein. The screen editing module 26 divides a display frame to be displayed on the display device 13 into pluralities.

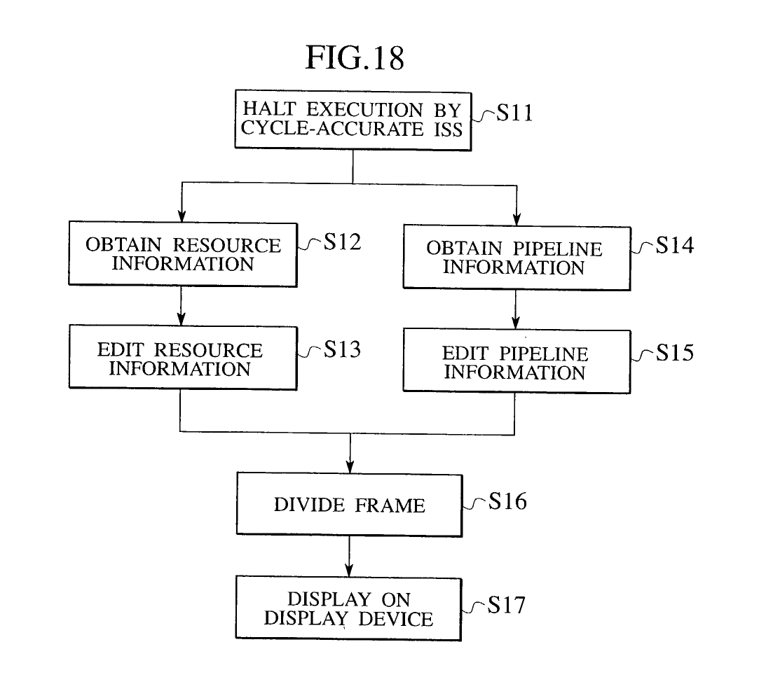

Next, description will be made regarding operations of the source code debugger 1 of the fifth embodiment with reference to FIG. 18.

(a) Since Steps S11 to S15 are similar to Steps S11 to S15 of FIG. 12 described in the first embodiment, explanation thereof will be omitted herein.

(b) In Step S16, the screen editing module 26 divides a frame into pluralities for displaying information obtained by the resource information displaying module and the pipeline information displaying module, and the screen editing module 26 performs suitable editing for display on the display device 13.

(c) Next, in Step S17, the display frame edited by the screen editing module 26 in Step S16 is displayed on the display device 13. In this way, it is possible to grasp the current position of the execution of the program, the progress of processing at the respective stages, register information and the like on one screen.

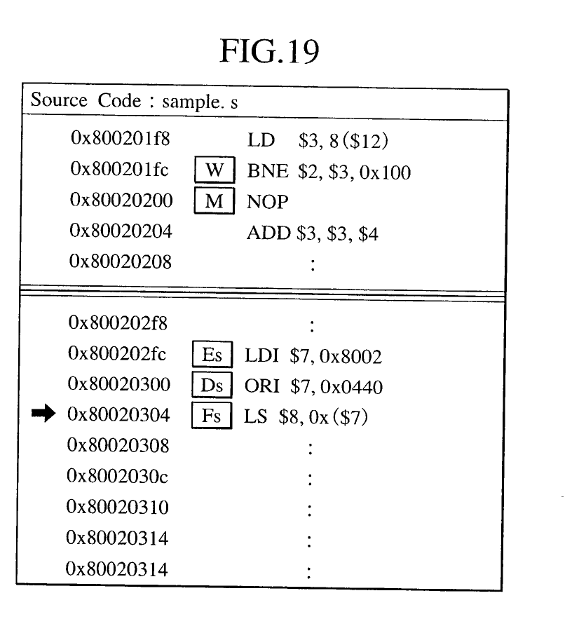

FIG. 19 is a view showing one example of displaying a source code frame by dividing into two sections. If the position of the execution of the program is changed by a branching instruction or the like, there is a case depending on a branched address that all the stage information cannot be displayed on the source code at once.

Here, it is assumed that the frame in FIG. 19 can display a maximum of fifteen lines at once, for example. As the program is branched toward the address 0x800202fc by the branching instruction at the address 0x800201fc, five instructions are in execution on the pipeline at the addresses 0x800201fc, 0x80020200, 0x800202fc, 0x80020300 and 0x80020304. However, since the region from the address 0x800201fc to the address 0x80020304 consists of 67 lines, it is impossible to display all the lines at once. In this case, the source code frame is divided upon display by the screen editing module 26 so that all the related lines can be displayed at once.

Upon frame division, continuous examples of the addresses for the instruction in execution on the pipeline are checked first and then the frame is divided accordingly to effectuate display, for instance. In FIG. 16A, three stages of F, D and E, and two stages of M and W are severally continuous addresses. Therefore, fourteen lines obtained by subtracting one line for a border from the maximum fifteen lines are divided at a proportion of 2:3, whereby five lines are provided for a first frame (a frame above the border) and nine lines are provided for a second frame (a frame under the border). However, it is to be noted that the mode of frame division is not particularly limited to the above-described mode in the present invention. It is also possible to adopt another mode based on a different algorithm. In addition, the number of display frames is not limited to two divisions, and multiple divisions into more than two frames is also applicable.

Moreover, the frame subject to division is not limited to the display frame for the source code. It is also possible to divide the register information display frame as described in the fourth embodiment.

According to the source code debugger of the fifth embodiment, it is possible to display all the instructions in execution on the pipeline on one frame. In this way, it is possible to grasp the situation of the pipeline of the processor completely.

(Other Embodiments)

Although the present invention has been described with reference to certain embodiments, it should be understood that the present invention is not limited to the explanations and the drawings which constitute part of the disclosure. It is obvious to those skilled in the art that various substitutions, examples and operational techniques become feasible based on the teachings of the disclosure.

For example, in the embodiments of the present invention, the positions for indicating the stage information is provided as being between the addresses and the instruction codes and the arrow for indicating the position of the PC is provided as being at the left end. However, those positions are not limited to the above-described modes, and those indication signs can be displayed in any position on the source code as long as the correspondence between the stage information and the instruction codes in execution at those stages is apparent.

Moreover, although the display frame consists of one window according to the embodiments of the present invention, it is also possible to provide for a plurality of windows. In this case, a variety of display combinations becomes feasible, such as a combination of displaying the stage information on one window while displaying the stall information of the stages on the other window, and so forth.

Various modifications will become possible for those skilled in the art after receiving the teachings of the present disclosure without departing from the scope thereof.

What is claimed is:

1. A source code debugger connected to a cycle-accurate instruction set simulator, comprising:
a pipeline information obtaining module configured to obtain address information in execution at respective stages on a pipeline from the cycle-accurate instruction set simulator;
a pipeline information displaying module configured to edit the address information of the pipeline obtained by the pipeline information obtaining module together with the progress of processing of the stages;
a resource information obtaining module configured to obtain address information of a program in execution together with instruction codes; and
a resource information displaying module configured to edit the address information and the instruction codes obtained by the resource information obtaining module.

2. The source code debugger according to claim 1, wherein the pipeline information obtaining module obtains the address information in execution at the respective stages on a plurality of pipelines from the cycle-accurate instruction set simulator having the plurality of pipelines, and the pipeline information displaying module edits the address information severally regarding the plurality of pipelines together with the progress of processing of the stages.

3. The source code debugger according to claim 1, further comprising a display device configured to display the address information, the progress of processing of the stages and the instruction codes by the pipeline information displaying module and the resource information displaying module in concert.

4. The source code debugger according to claim 1, wherein the pipeline information obtaining module further obtains stalling information of the stages of the respective instructions in execution on the pipeline, and the pipeline information displaying module further edits the stalling information into a source code of the program.

5. The source code debugger according to claim 1, wherein the pipeline information obtaining module further obtains register information targeted by the respective instructions in execution on the pipeline, and the pipeline information displaying module further edits the register information.

6. The source code debugger according to claim 3, further comprising a screen editing module configured to divide a display frame and to display the divided display frame on the display device.

7. A source code debugger connected to a cycle-accurate instruction set simulator, comprising:
means for obtaining address information in execution at respective stages on a pipeline from the cycle-accurate instruction set simulator;
means for editing the address information of the pipeline obtained by the pipeline information obtaining means together with the progress of processing of the stages;
means for obtaining address information of a program in execution together with instruction codes; and
means for editing the address information and the instruction codes obtained by the resource information obtaining means.

8. A method for use in a system comprising a source code debugger and a cycle-accurate instruction set simulator connected to the source code debugger, comprising:
obtaining address information in execution at respective stages on a pipeline from the cycle-accurate instruction set simulator;
editing the address information of the pipeline together with the progress of processing of the stages;
obtaining address information of a program in execution together with instruction codes; and
editing the address information and the instruction codes.

9. The method according to claim 8, further comprising:
obtaining the address information in execution at the respective stages on a plurality of pipelines from the cycle-accurate instruction set simulator having the plurality of pipelines; and
editing the address information in execution and the progress of processing of the stages.

10. The method according to claim 8, further comprising displaying the address information, the progress of processing of the stages and the instruction codes on a display device.

11. The method according to claim 10, further comprising:
obtaining stalling information of the stages of the respective instructions in execution on the pipeline; and
displaying the stalling information on the display device.

12. The method according to claim 10, further comprising:
obtaining register information targeted by the respective instructions in execution on the pipeline; and
displaying the register information on the display device.

13. The method according to claim 10, further comprising editing so as to display a divided display frame on the display device.

14. A computer program product for controlling a system comprising a source code debugger and a cycle-accurate instruction set simulator connected to the source code debugger, comprising:
instructions configured to obtain, by pipeline information obtaining, address information in execution at respective stages on a pipeline from the cycle-accurate instruction set simulator;
instructions configured to edit, by pipeline information displaying, the address information of the pipeline together with progress of processing of the stages;
instructions configured to obtain, by resource information obtaining means, address information of a program in execution together with instruction codes; and
instructions configured to edit, by resource information displaying module, the address information and the instruction codes.

15. The computer program product according to claim 14, further comprising:
instructions configured to obtain the address information in execution at the respective stages on a plurality of pipelines from the cycle-accurate instruction set simulator having the plurality of pipelines; and
instructions configured to edit the address information in execution and the progress of processing of the stages.

16. The computer program product according to claim 14, further comprising instructions configured to display the address information, the progress of processing of the stages and the instruction codes on a display device.

17. The computer program product according to claim 16, further comprising:
instructions configured to obtain stall information of the stages of the respective instructions in execution on the pipeline; and
instructions configured to display the stall information on the display device.

18. The computer program product according to claim 16, further comprising:
instructions configured to obtain register information targeted by the respective instructions in execution on the pipeline; and
instructions configured to display the register information on the display device.

19. The computer program product according to claim 16, further comprising instructions configured to edit so as to display a divided display frame on the display device.
